(19) United States
(12) Patent Application Publication
(10) Pub. No.: US 2006/0239586 A1
(43) Pub. Date: Oct. 26, 2006

(54) System and method to simulate film or other imaging media

(75) Inventor: Craig Mowry, Southampton, NY (US)

Correspondence Address: OSTROLENK FABER GERB & SOFFEN, 1180 AVENUE OF THE AMERICAS, NEW YORK, NY, 100368403, US

(73) Assignee: CRAIG MOWRY PRODUCTIONS INC.

(21) Appl. No.: 11/408,389

(22) Filed: Apr. 20, 2006

Related U.S. Application Data
(60) Provisional application No. 60/672,965, filed on Apr. 20, 2005.

(51) Int. Cl. G06K 9/64

(52) U.S. Cl. 382/278

(57) ABSTRACT

In one embodiment, the present invention includes a media simulation system that provides at least one lens operable to optically relay a single visual scene, and a first visual medium and a second visual medium. The first imaging medium and the second imaging medium are each operable to capture and store respective images of the single visual scene. Further, the respective images stored on the first imaging medium are correlated with the respective images stored on the second imaging medium. Also provide is a data management program operable on a computing device to selectively apply aspects of the respective images stored on the first imaging medium to modify corresponding aspects of the respective images stored on the second imaging medium.

### CROSS-REFERENCE TO RELATED APPLICATION

This application claims priority from U.S. Provisional Patent Application Ser. No. 60/672,965, filed Apr. 20, 2005, entitled SYSTEM AND METHOD TO FACILITATE TIME CODE CROSS REFERENCING BETWEEN FILM AND DIGITALLY ORIGINATED IMAGES, WHICH WERE CAPTURED SIMULTANEOUSLY THROUGH THE SAME LENS, the entire disclosure of which is hereby incorporated by reference.

### BACKGROUND

1. Field of the Invention

The present invention relates, generally, to imaging and, more particularly, to media simulation and generating images therefor.

2. Description of the Related Art

As digital imaging replaces much of the filmed image origination of the past, aesthetic and artistic issues arise for many in the industry. The change from photo chemical to electronic media capture and the change in equipment, from film cameras to video cameras, have contributed largely to these issues. U.S. Pat. No. 5,687,011 (the “'011 patent”) to Mowry discloses an approach to digital film simulation.

In particular, the '011 patent discloses a hybrid camera that bridges the “gap” between electronic (e.g., digital) capture and film capture. The camera presents both capture techniques interdependently, thereby allowing for a new range of creative and artistic options, including filmic image results, while simultaneously maintaining the efficiency and cost effectiveness, well-known to those skilled in the art of digitally originated productions.

So-called “media simulation” refers herein, generally, to a process of manipulating images captured with one medium to mimic images associated with another capture medium. For example, images that are in digital format may not appear as images that are captured on film. The digital images are modified to simulate the film images, for example, by adjusting color, resolution, sharpness, or the like. In an alternative example, filmed images are modified to simulate digital images. As known to those skilled in the art, media simulation is an important aspect of consumer and entertainment imaging. In a media simulation, visuals are, typically, manipulated or at least passed through a digital realm at some point before provided in a final form.

Imaging in the entertainment industry continues to focus on maintaining the aesthetics of film origination in an ever growing number of productions that are shot digitally. These productions are typically based on data transforms from media sampling, unlike the discreet method disclosed in the '011 patent wherein the actual film media to be simulated is involved at capture to inform the modification process of digital images using film that was actually exposed at capture. This is distinct from a software program suggesting how film might have rendered the lens image under certain conditions at capture.

As further disclosed in the '011 patent, film and video originate in tandem for the specific purpose of aesthetically modifying the video-originated visuals. The benefit of cross-referencing the media at initial capture and/or store, is allowing for proper image reference of images originated of a selected scene on one medium with images originated on another medium of the same visual scene, whether through a single or multiple lenses. Unfortunately, no technique or system is available in the prior art that provides a user with an automated way to cross-reference the media easily in relation to a multi-media capture, media simulation system.

### SUMMARY

The present invention includes a media simulation system that provides at least one lens operable to optically relay a single visual scene, and a first visual medium and a second visual medium. The first imaging medium and the second imaging medium are each operable to capture and store respective images of the single visual scene. Further, the respective images stored on the first imaging medium are correlated with the respective images stored on the second imaging medium. Also provide is a data management program operable on a computing device to selectively apply aspects of the respective images stored on the first imaging medium to modify corresponding aspects of the respective images stored on the second imaging medium.

In an alternative embodiment, the present invention includes a media simulation software application operable on a computing device. The application includes an image receiving module operable to receive respective images captured by a plurality of media, and an image modification module operable to modify image data derived from at least some of the respective images in relation to non-image data provided by at least one of the plurality of media. At least some images originating from a first of the plurality of media are selectively modified based on data from corresponding aspects of images captured on a second of the plurality of media. The respective images are captured by the plurality of media through a single lens.

Yet another embodiment includes a film simulation system that includes photographic film that is exposed through a lens to capture visuals. The photographic film has a data storage aspect for additional information other than imaging information. Also included is an electronic capturing means to capture the visuals through the lens, and means for cross-referencing the visuals captured on the electronic capturing means with selected portions of the visuals captured on the photographic film.

A still further embodiment regards a media simulation system that includes a lens for relaying visuals, and a visual data recording medium used for recording the visuals relayed through the lens and for recording cross-referencing data. Moreover, an electronic capture medium is provided that is operable to electronically capture the visuals relayed through the lens. The visuals that are electronically captured by the electronic capture medium are cross-referenced during post production processes with selected aspects of the visuals recorded by the visual data recording medium in relation to cross-referencing data.

These and other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates a multi-media hybrid camera operable to capture a single lens-relayed image with film and digital media in accordance with a preferred embodiment;.

FIG. 2 shows film following photo-chemical processing and tape media, and illustrating the time code cross referencing data aspects and key frame approach, wherein a single filmed image may affect multiple electronically captured images in accordance with a preferred embodiment;

FIG. 3 illustrates a data modifying computing device associated with a data modification program, in accordance with a preferred embodiment; and

FIG. 4 shows an example final digital media which may contain modified images that are output by a data store containing images created from a plurality of media captures, associated with corresponding time code data for exacting cross-media referencing to provide media simulation modification in accordance with an example embodiment of the present invention.

### DETAILED DESCRIPTION OF THE PREFERRED EMBODIMENTS

Preferably, a system and method is disclosed that provides non-visual data that are preferably stored on a media while a camera captures a visual scene, referred to herein, generally as a “visual,” to a plurality of media. As used herein, “non-visual data” refer, generally, to any data that are not the digital image data included in an image. The term, “non-visual data” is not meant to exclude data that cannot be seen; instead, non-visual data are data that are not included in an image.

A first of the plurality of media may be, for example, film, and a second of the plurality of media may be, for example, a digital storage device. The non-visual data may be stored in either media, and are preferably used during a process to modify digital images of the visual by cross-referencing the images stored on one medium (e.g., film) with the images stored on the other medium (e.g., digital storage device). Using the non-visual data, digital images can be cross-referenced with respective non-digital images, and the digital images can be modified without a need for user input or instructions to identify respective. Any user input, for example, for aesthetic adjustments, are not necessarily eliminated.

As known in the art, several approaches are relied upon for cross-referencing media, for example, in double system sound and non-linear editing systems, in order to assign and cross-reference visuals based on data recorded, typically, on various media that are utilized. Preferably, cross-referencing media is used in a hybrid camera configuration for the purpose of media simulation, and of film origination for eventual modification of visuals that are also electronically captured. Preferably, images recorded on a plurality of media are delivered though a single lens, separately recorded, and cross-referenced in relation to data stored in the cross-referencing media.

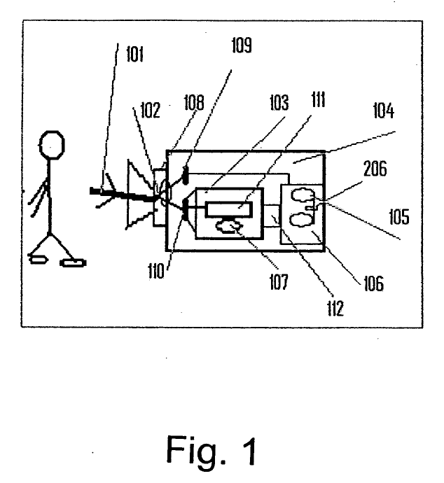

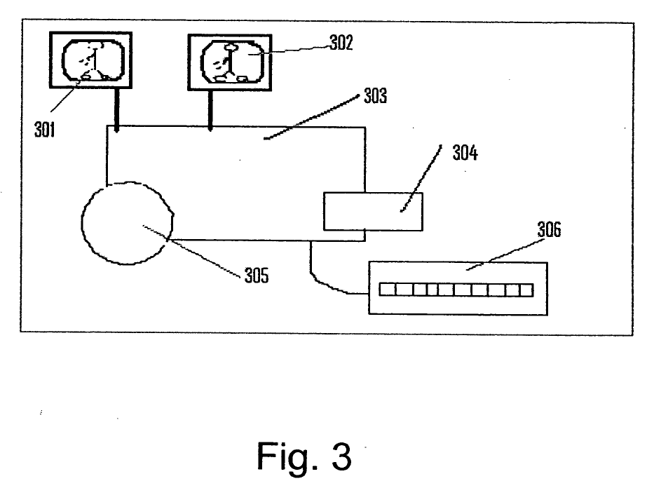

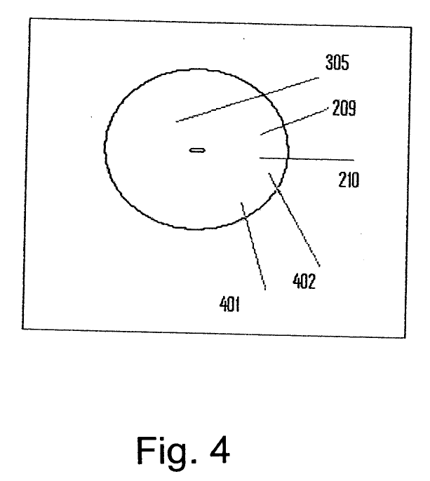

The following description refers to the accompanying drawings, in which like reference numerals refer to like elements. Below is list of some reference numerals and corresponding elements illustrated in FIGS. 1-4, in accordance with the preferred embodiments:

101—visual scene

102—beam splitter/image diverter

103—film stock

104—hybrid multi-media camera

105—videotape or other electronic storage or drive

106—digital visual data recorder

108—lens

109—digital image capture device (such as ccd)

110—film exposing gate and shutter

112—time code generator providing data to both media for recording

201—magnetic, visual or other recording media for non-visual data

203—film image and corresponding selected number of digital images to be modified by data from the single filmed image

205—magnetic media or other option for storing digitally originated images

206—digital visual recording head or other (to tape or other)

208—time code/non visual data recording means

209—non-visual digitally captured image reference data (transferred from original media)

210—non-visual filmed image reference data (transferred from original media)

301—monitor display of digitally originated image

302—film simulating modified digitally originated image, replacing image aspects based on image and on image data corresponding to digitized film originated images (as displayed on a display monitor)

303—digital image modifying computer

304—film originated image referencing, digital image modification program

305—high definition dvd or other storage option

306—user input device, such as keyboard, for optional aesthetic and functional instructions

401—digitally originated visual data

402—film originated image data

In a preferred embodiment, a simple and cost effective configuration of the film simulating, hybrid digital camera disclosed in the '011 patent, such as shown in specifically in FIG. 8, is used to record non-visual data to provide cross-reference, non-visual information on at least one of a plurality of media. Preferably, small gauge film 103, such as 8 mm film stock, is used to provide emulsion color response information.

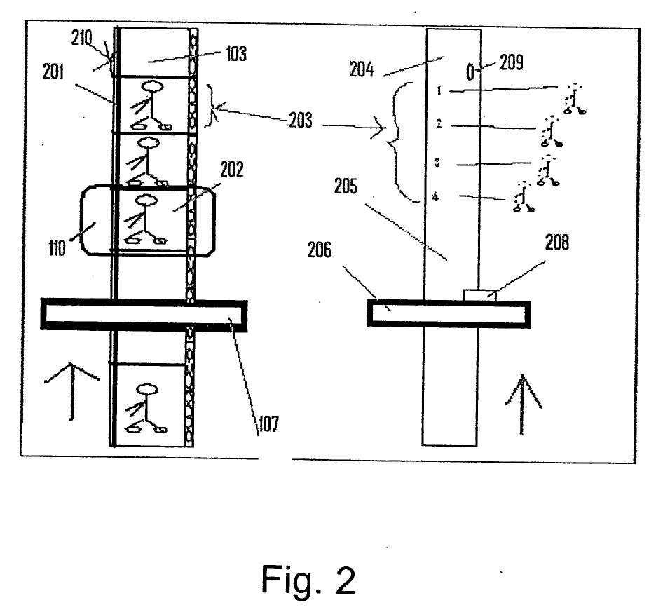

In a preferred embodiment, a familiar cartridge-based product involving the known super 8 mm film stock, commonly referred to as the super 8 sound cartridge, is an example of a useful application of the film aspect of an embodiment. Typically, consumer film cameras utilize this product or similar products, which allow for sound to be recorded live onto magnetic stripe 201 (FIG. 2), preferably a magnetic material added to the film stock as a continual, thin strip and uninterrupted through the entire length of the stock. The sound is synchronized with the visual images on the film. Magnetic stripe 201 is preferably electronically recordable media placed to the side of the emulsion area where visuals are recorded, and optionally also to the small outside space next to the sprocket holes comprised in the film stock.

With the aesthetic advantage of any selected emulsion type film stock being provided selectively in the super 8 sound cartridge containment, in a preferred embodiment, a double media system is provided for recording for eventual digital modification of high definition digitally originated images. Of course, one skilled in the art will recognize that any other electronically captured visual format can be used. The digitally oriented images are cross-referenced with images in a non-digital media during post production processes. Accordingly, an electronic time code or related data generated by the electronic capture aspect of camera 104 (FIG. 1), for example the digital image capture portion of the camera, is herein relayed electronically. The data (e.g., time code data) are not only conveyed and stored within the storage means for the digital/electronically captured visuals 105 (such as tape or a drive, or other such storage options), but also conveyed to film capture 111 portion of the camera for storage within an aspect of the selected film stock.

Film capture unit 111, preferably configured to accommodate the super 8 sound cartridge, also includes magnetic recording head 107, familiar to those skilled in the art, and used in super 8 sound recordings. Magnetic recording head 107 preferably provides electronic stimulus for the magnetic sound stripe 201 added to the film stock to receive and store data, for example, related to microphone recorded sound. These data are preferably recorded several frames offset from the portion of the film emulsion being recorded at the same moment, thereby allowing proper space for the components of the camera.

Preferably, the time code data 210 are provided by magnetic recording head 107 to magnetic sound stripe 201 by camera time code generator 112, which provides data for recording on both the reference media (such as film) and digital media (such as compact flash memory) containing the images to be later modified. Whether 24 frames per second (“FPS”), 1 FPS or slower, there is ample magnetic media to store all necessary time code data, or equivalent types of data, regardless of the frame rate at which the digitally originated images are captured. Once the film stock is processed in the selected digitizing process, the sound stripe data are read and provided to electronic recording media used to store the digitized film visuals, such as a high definition DVD, or computer drive.

One benefit provided by the teachings herein is that filmed images may be captured at a vastly different frame rate than images captured by video. This is unlike typical prior art 24 fps film productions that include video assist footage captured at the same frame rate and used for cross-referencing purposes. Preferably, a software program 304, included in an embodiment and operable on a computing device, addresses frame rate variation options, and applies data stored on magnetic stripe 201 that represent a series of electronically captured visuals 203, selectively, to address the special application of one filmed key frame providing the subsequent digital data to modify any selected number of digitally (electronically) captured and stored images.

In other embodiments, magnetic components and recording material may be replaced by other data recording options that allow for acceptable recorded image cross-referencing during post production processes. One example of another option is visual recording onto the film emulsion, and further using a bar code or other selected data encoding visual record. Selectively, each and every filmed visual may selectively (though not necessarily) have an emulsion stored visual data aspect imprinted (exposed) onto the emulsion by a visual stimulus component of hybrid, multi-media camera 104. Selectively close to the filmed frame that the visual data aspect relates to, this bit of emulsion stored data may also be offset from the frame(s) to which they correspond, reciprocally when read by a subsequent data aspect reading means, (such as laser or other visual scanning device). This optional offset is compensated and corrected to allow the proper recorded data aspect to reference the correct filmed image, once the filmed material is photo-chemically processed and selectively digitized or otherwise scanned and stored as an electronic media facsimile of the filmed images. Alternatively, existing image reference data markers present in the utilized film stock may be read during exposure of the film stock, thereby enabling recording relative to the electronically captured images. This provides a reliable data link between the media for subsequent identification of system-relevant corresponding images between media.

Prior art approaches to such emulsion based data aspects include KODAK datacode as well as the sound synching emulsion recording data of AATON film camera systems. These allow for visual data within material filmed with cameras to provide data tracked visuals for cross referencing for double system sound recording, and editing. In contrast, software is preferably used to provide a visual-to-visual(s) reference, link selected visuals of different media recorded at the same or varying frame rates for the purpose of infusing aspects of one media appropriately into aspects of another. This linking enables an automatic media reference in post production for selected modification of data within the images captured and stored on one of the various media embodied within the hybrid camera capture device 104 (or devices should the “camera” take the form of multiple units, of differing media, working in tandem as one cooperative, multimedia capturing system).

Further, the option of prerecorded filmed frame reference data within film stock yet to be exposed to image data, may be provided for reading and recording by the hybrid camera unit or system 104. Prerecorded filmed frame reference information can be used for recording data within the electronic recording means of the electronic capture aspect of the system, or for electronic recording of data separately, such as with a secondary data referencing means to electronically captured images.

An alternative embodiment includes a system to cross reference filmed and electronically captured material that includes a configuration including variously selected media, which may be electronic or otherwise, and including individual visual capture or motion imaging. This alternative embodiment enables discreet media simulation by referencing data that are specific to image modification for such simulation, regardless of the various media involved.

Preferably, computer executed instructions (e.g., included in software) are employed by a computing device. The computing device may be any device that is capable of sending and receiving data across a communication network, e.g., a mainframe computer, mini computer, personal computer, laptop computer, a personal digital assistant (PDA) and an internet access device such as Web TV. The software preferably includes a data management application that employs selective image zone modification transforms, thereby allowing filmed visuals to provide a discreet basis for modification of digitally originated images. Corresponding image zones and/or aspects may be identified by one of a selective combination variety of existing digital means, based on the desired aesthetic and degree of detail and modification detail desired in a given configuration of the application. This program relies herein on the data link provided between the media, to distinguish those images relevant in modifying others, between media. This data will provide the framework for the selective, media simulating modification process. (This non visual data is not limited to time code data, or the like, and potentially includes user input data at capture, automatically gathered data related to camera settings and lighting conditions, or other data useful in the digital modification stage).

Continuing with reference to FIG. 1, hybrid camera 104 captures a visual scene 101 through lens 108, which may comprise two or more distinct lenses in an optional configuration, thereby collecting slightly offset images. Beam splitting, other image splitting means 102 or selected staggered relay of selectively all of the lens image, delivers a selected portion of the light from the scene photographed through the lens to digital capture device 109 and film gate 110 where a selected film stock with emulsion recording means moving intermittently, 103 receives and records the lens light as a latent photographic image 202, preferably, for subsequent chemical processing and digitizing.

The digital capture is recorded by digital recorder 106 by way of recording component, including options such as magnetic recording means 206 and recorded within storage 105 which may be magnetic tape, (and 204, a detail of such tape), computer drive or other recording media, as known in the art. In accordance with the teachings herein, captured visual reference data is selectively generated by data generator 112, recorded, (or read in another optional configuration) by data providing component 107 which exposes film stock 103, magnetic material 201 or other media by way of data providing/recording component 107 to specific data relevant stimuli to create readable data record, of selective size (to not interfere with image recording), and recorded selectively with a selected frame offset, such as that typical to that of the super 8 sound recording sound/visual frame offset. Again, this data stimuli for exposing non image data onto the film is selectively created from data selectively generated by hybrid camera time code generator 112 as image correlating (or other image reference) data, which is also recorded in relation to selected image data with, or in relation to, digital capture image data stored. Such data recorded relative to the digital capture material is delivered by recording component 208 to the selected digital data store option, such as magnetic tape.

A post production aspect includes, though is not limited to, film 103 being chemically processed and digitized, with data recorded by component 107 being recorded as an aspect of, or in relation to, these stored, digitized film originated images. In case the media involved are both electronically originated, such processing and digitizing is preferably bypassed. Computer(s) 303 preferably receives image and non-image data from all relevant media, 103 and 204, and maintains them within a selected memory, and employs the non-image data to correctly match corresponding film originated image(s) with selected digitally originated image(s). A single filmed image, or filmed “key frame,” may provide data for modification of data related to many digitally originated images, 203. This may selectively occur in the process of actual modification of digitally originated images based on the filmed images, 201 or in an intermediary stage of creating a subsequent data store, (such as a DVD 305 or other media) which embodies all image 401, 402 and non-image data 209, 210 from all media used at capture, synched/correlated prior to delivery to further computing means for use in image data, media simulation modifications, or other selected image modifications.

Thus, the creation of a distinct data store 305 (whether as one piece of media or more than one slaved to work in tandem) embodying all image and non image data as an aspect of a modification program, where selectively automatically image aspects and/or zones of data from one medium is correlated with and modified in accordance with image data from another medium and wherein data from a single image of one medium, such as film, may be applied to a series or sequence of images originated on another medium, such as digital. Distinct software 304 capable of employing such a unique data store may be provided, employable by the data modifying computer 303, wherein the computer system user may load media into a memory and by virtue of the unique synching and selective modification process, see all digitally originated images, (or just selected images determined to be the “final edit” of a project), as modified, film simulating images; borrowing on image aspects of one medium selectively to simulate that medium, from another medium display 301 displays the images related to unmodified media with monitor 302 displaying final visuals, modified by and for the purposes described herein. Final aesthetic visual adjustments, subjective to the system user, by way of data inputting component 306, (or other means,) may be employed at this point, based on visuals viewed on monitor 302.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A media simulation system, the system comprising:
at least one lens operable to optically relay a single visual scene;
a first visual medium and a second visual medium, wherein the first imaging medium and the second imaging medium are each operable to capture and store respective images of the single visual scene, wherein the respective images stored on the first imaging medium are correlated with the respective images stored on the second imaging medium; and
a data management program operable on a computing device to selectively apply aspects of the respective images stored on the first imaging medium to modify corresponding aspects of the respective images stored on the second imaging medium.

2. The media simulation system of claim 1, wherein the respective images stored on the first imaging medium are correlated with the respective images stored on the second imaging medium in relation to non-visual data.

3. The media simulation system of claim 1, wherein the first imaging medium includes a magnetic recording medium.

4. The media simulation system of claim 3, wherein the magnetic recording medium stores data related to time code data recorded on the second imaging medium.

5. The media simulation system of claim 3, wherein the magnetic recording medium is provided separately from the image recording medium.

6. The media simulation system of claim 2, wherein the non-visual data is stored as a visual data element recorded within the first visual medium.

7. The media simulation system of claim 6, wherein the visual data aspect is a readable data code or a bar code.

8. The media simulation system of claim 1, wherein the first imaging medium is photographic film.

9. The media simulation system of claim 1, wherein the first imaging medium has first data prerecorded onto thereon, and further wherein the second imaging medium is provided with recordable data during image capture that is stored thereon that relates to the first data on the first imaging medium.

10. The media simulation system of claim 2, wherein the non-visual data comprises a data code.

11. The media simulation system of claim 1, wherein the first imaging medium is motion picture film, and the second imaging medium is operable as a digital capture and store system.

12. The media simulation system of claim 1, wherein first imaging medium and the second imaging medium, when recording visual information, do not record the same number of visuals over a period of time.

13. The media simulation system of claim 1, wherein first imaging medium and the second imaging medium have the same number of visuals over a period of time recorded thereon.

14. The media simulation system of claim 2, wherein non-visual data enables subsequent automatic alteration of selected images recorded on the first imaging medium by a computing device in relation to visuals identified in relation to the respective images stored on the second imaging medium.

15. The media simulation system of claim 1, wherein the respective images on the first and second imaging media are subsequently provided in electronic form to a computing device for modifications toward media simulation.

16. The media simulation system of claim 1, wherein the visual scene is recorded simultaneously on the first and second imaging media.

17. The media simulation system of claim 1, wherein the images stored on first and second imaging media are captured through a plurality of lenses.

18. The media simulation system of claim 1, wherein a single subsequent storage means includes image and other data relative to the images.

19. The media simulation system of claim 1, wherein a single subsequent memory means accessible by a computer includes image and other data relative to the images.

20. The media simulation system of claim 19, wherein the storage means is a DVD.

21. The media simulation system of claim 19, wherein the non-visual data are time code data.

22. A media simulation software application operable on a computing device, the application comprising:
an image receiving module operable to receive respective images captured by a plurality of media;
an image modification module operable to modify image data derived from at least some of the respective images in relation to non-image data provided by at least one of the plurality of media;
wherein the at least some images originating from a first of the plurality of media are selectively modified based on data from corresponding aspects of images captured on a second of the plurality of media, and further wherein the respective images are captured by the plurality of media through a single lens.

23. The media simulation system of claim 22, wherein one of the plurality of media is film.

24. A film simulation software application operable on a computing device, the application comprising:
an image data aspect operable to derive image data from respective images, wherein some of the respective images are captured and originally stored electronically, and some of the respective images are captured and originally stored within film emulsion; and
a correlating aspect operable to use non-image data in order to selectively modify at least some of the respective images stored in the digital medium in relation to the image data derived from the respective images stored within the film emulsion,
wherein the correlating aspect modifies the at least some images based on corresponding aspects of the images stored within the film emulsion,
wherein both the respective images originally stored in the digital medium and the respective images stored originally within the film emulsion were captured through a single camera lens, and
further wherein the non-image data is stored during the capturing of the respective images.

25. A film simulation system, the system comprising:
photographic film that is exposed through a lens to capture visuals, wherein the photographic film has a data storage aspect for additional information other than imaging information;
electronic capturing means to capture the visuals through the lens;
means for cross-referencing the visuals captured on the electronic capturing means with selected portions of the visuals captured on the photographic film.

26. The film simulation system of claim 25, wherein the information is time code data.

27. A film simulation system, the film simulation system comprising:
a lens providing visuals to be captured as filmed images on photographic film and to be captured as electronic images on an electronic capture means, wherein the film images and the electronic images are captured substantially simultaneously; and
means for providing frame reference data to a recordable aspect of the photographic film, wherein time code data enables the electronic images to be cross-referenced with the film images, and further wherein the electronic images are selectively modifiable in relation to cross-referenced film images.

28. A film simulation system, the system comprising:
photographic film for storing images;
an electronic imaging medium capture and data recording means for storing the images;
a lens for substantially simultaneously providing the images captured through the lens to be stored in the photographic film emulsion and as a data recording related to the electronic imaging medium capture;
means to reference at least time code relevant data relative to aspects of the photographic film, wherein the time code data enables cross-referencing of the images stored on the photographic film and on the electronic imaging medium capture and data recording means, thereby enabling at least some of the images stored on the electronic medium to be modified in relation to the cross-referenced images stored in the photographic film emulsion.

29. A system for modifying electronically captured images in relation to substantially the same images as captured within photographic film emulsion, the system comprising:
an electronic capture means operating in tandem with the photographic film exposing means; and
a cross-referencing means for cross-referencing electronic visual data from digitized visuals derived from the photographic film and the electronically captured visuals used for selectively modifying the electronically captured visuals.

30. A media simulation system, the media simulation system comprising:
a lens for relaying visuals;
a visual data recording medium used for recording the visuals relayed through the lens and for recording cross-referencing data; and
an electronic capture medium operable to electronically capture the visuals relayed through the lens,
wherein the visuals electronically captured by the electronic capture medium are cross-referenced during post production processes with selected aspects of the visuals recorded by the visual data recording medium in relation to cross-referencing data.

31. The media simulation system of claim 30, wherein the cross-referencing data are time code data.

32. A media simulation system, the system comprising:
a selected visual data recording medium that records first scene images of a first scene, and further that stores reference data; and
an electronic capture medium that electronically captures second scene images of a second scene,
wherein the reference data enables subsequent cross-referencing between the second scene images and selected aspects of the first scene images.

33. The media simulation system of claim 32, wherein the visual data recording medium is photographic film.

34. The media simulation system of claim 32, wherein the first scene and the second scene are identical.

35. The media simulation system of claim 32, wherein the first scene and the second scene are similar.

36. An apparatus for recording visuals that are captured through a single lens on more than one recording medium, the apparatus comprising:
a first recording medium recording the visuals relayed through the single lens;
a second recording medium recording the visuals relayed through the single lens;
a data record provided within at least one of the first recording medium and the second recording medium, wherein the data record embodies media cross-referencing data; and
an altering module that alters at least some of the recorded visuals of the first recording medium in relation to data recorded by the second recording medium that are cross-referenced in relation to the cross referencing data.

37. The apparatus of claim 36, wherein the cross referencing data is time code data.

38. A camera, the camera comprising:
a lens through which a first scene is captured;
a photographic image recording medium being exposed to and recording selected visual data relating to the first scene; and
an electronic capturing medium capturing and relaying to a data store a second scene captured through the lens, wherein an aspect of the photographic image recording medium is provided with and stores non-visual image reference data for post production cross-referencing between aspects of first visuals included in the first scene and second visuals included in the second scene.
